(19) United States
(12) Patent Application Publication
(10) Pub. No.: US 2013/0052620 A1
(43) Pub. Date: Feb. 28, 2013

(54) PLATFORM MECHANICS

(71) Applicants: Alexander Salem Franklin, Redwood City, CA (US); David Jonq Wang, Palo Alto, CA (US); Wayne Eugene Greenwood, La Honda, CA (US); Mark A. Ross, San Carlos, CA (US); Conway Thomas Chen, West Los Angeles, CA (US)

(72) Inventors: Alexander Salem Franklin, Redwood City, CA (US); David Jonq Wang, Palo Alto, CA (US); Wayne Eugene Greenwood, La Honda, CA (US); Mark A. Ross, San Carlos, CA (US); Conway Thomas Chen, West Los Angeles, CA (US)

(73) Assignee: STRIIV, INC., Redwood City, CA (US)

(21) Appl. No.: 13/601,743

(22) Filed: Aug. 31, 2012

Related U.S. Application Data
(60) Provisional application No. 61/529,657, filed on Aug. 31, 2011.
(60) Provisional application No. 61/529,674, filed on Aug. 31, 2011.

(51) Int. Cl. G09B 19/00

(52) U.S. Cl. 434/236

(57) ABSTRACT

Platform mechanics including the generation and consumption of energy-based virtual currency are described. A method of generating energy-based virtual currency includes receiving a signal generated by a sensor carried by a user. The method also includes analyzing the signal to validate that an activity was performed by the user in the real world or that a state associated with the user occurred in the real world. The method also includes awarding energy-based virtual currency to the user in response to validating that the activity was performed by the user or that the state associated with the user occurred in the real world. A method of redeeming energy-based virtual currency includes receiving energy-based virtual currency that can be redeemed for value in a virtual world or in the real world. The method also includes redeeming at least some of the energy-based virtual currency for value in the real world.

### CROSS-REFERENCE TO RELATED APPLICATIONS

The present application claims the benefit of and priority to U.S. Provisional Application No. 61/529,657, filed Aug. 31, 2011 and entitled PLATFORM MECHANICS, and U.S. Provisional Application No. 61/529,674, filed Aug. 31, 2011 and entitled LIFE PATTERN DETECTION. Each of the foregoing patent applications is incorporated herein by reference in its entirety.

### BACKGROUND

1. Field of the Invention

The present invention relates to platform mechanics for electronic devices. More particularly, some example embodiments relate to the generation and consumption of energy-based virtual currency.

2. Related Technology

Unless otherwise indicated herein, the materials described herein are not prior art to the claims in the present application and are not admitted to be prior art by inclusion in this section.

Gaming platforms, such as the NINTENDO WII and MICROSOFT KINECT, support session-based game play. In particular, playing a game on these platforms requires the user to be actively engaged with the corresponding game console in a gaming session. If the user is not actively engaged with the game console, game play ceases.

In addition, such gaming platforms are typically confined to a particular location. Specifically, the corresponding game console typically requires connections to various stationary elements, such as an electrical outlet or other stationary power source and a television or other external display. Thus, even if the gaming platform includes a wireless controller or other wireless technology, the user is nevertheless confined to the vicinity of the game console if the user desires to engage in game play.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Techniques described herein generally relate to the generation and consumption of energy-based virtual currency.

In an example embodiment, a method of generating energy-based virtual currency is described. The method includes receiving a signal generated by a sensor carried by a user. The method also includes analyzing the signal to validate that an activity was performed by the user in the real world or that a state associated with the user occurred in the real world. The method also includes awarding energy-based virtual currency to the user in response to validating that the activity was performed by the user or that the state associated with the user occurred in the real world.

In another example embodiment, a method of redeeming energy-based virtual currency is described. The method includes receiving energy-based virtual currency that can be redeemed for value in a virtual world or in the real world. The method also includes redeeming at least some of the energy-based virtual currency for value in the real world.

In yet another example embodiment, a method of harvesting activities or states in the real world to drive events in a virtual world is described. The method includes receiving a signal generated by a sensor carried by a user. The method also includes analyzing the signal to validate that an activity or state associated with the user occurred in the real world. The method also includes driving an event in the virtual world in response to validating that the activity or state occurred.

These and other features of some example embodiments will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example environment in which some embodiments described herein can be implemented;

FIG. 2 illustrates an example system that can be implemented in the environment of FIG. 1;

FIG. 3 is a flowchart of an example method of generating energy-based virtual currency;

FIG. 4 is a flowchart of an example method of redeeming energy-based virtual currency;

FIG. 5 is a flowchart of an example method of harvesting activities or states in the real world to drive events in a virtual world; and

FIG. 6 illustrates an example embodiment of a lifestyle device that may be implemented in the environment of FIG. 1.

### DETAILED DESCRIPTION OF SOME EXAMPLE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

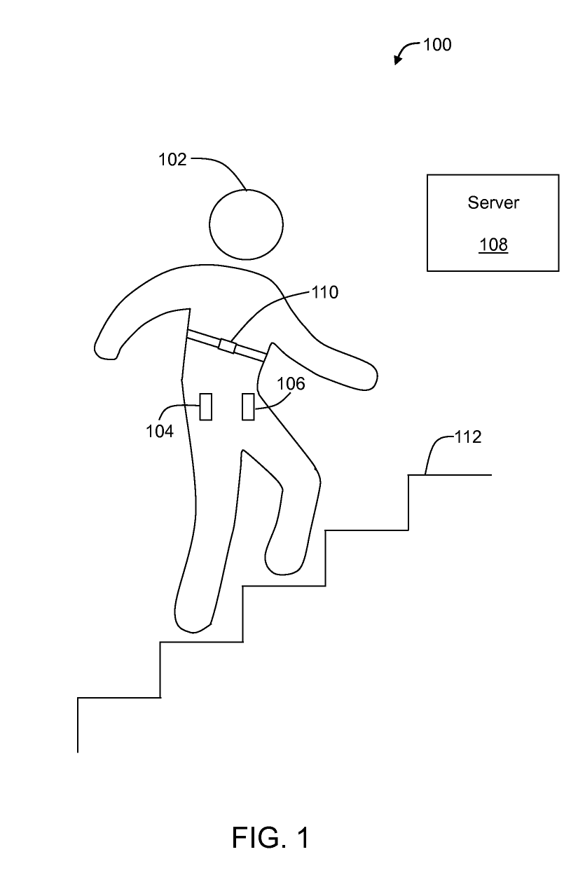

FIG. 1 illustrates an example environment 100 in which some embodiments described herein can be implemented. The environment 100 includes a user 102 and at least one of a lifestyle device 104 and a smartphone 106 or other mobile device. Optionally, the environment 100 further includes a server 108.

The environment 100 additionally includes one or more sensors. Each of the sensors is configured to collect signals indicative of physical activities performed by the user 102 and/or of activities or states associated with the user that occur in the real world. More particularly, each of the sensors may be configured to collect data that forms the respective signals.

All of the sensors may be included in a single device, such as the lifestyle device 104 or the smartphone 106. Alternately or additionally, the sensors may be distributed between two or more devices. For instance, one or both of the lifestyle device 104 or the smartphone 106 may include a sensor. Alternately or additionally, the one or more sensors may be provided as separate sensors that are separate from either of the lifestyle device 104 or the smartphone 106 and are configured to be carried by the user 102. For instance, a sensor 110 is provided as a separate sensor. In particular, the sensor 110 is separate from the lifestyle device 104 or the smartphone 106, and is embodied in FIG. 1 as a heart rate monitor or other physiological sensor configured to be worn by the user 102.

In some embodiments, the sensor 110 can include a sensor attached to the body of the user 102, or a sensor that is part of and/or monitors an environment surrounding the user 102. Various non-limiting examples of sensors that may be attached to the body of the user 102 include heart rate sensors, breathing sensors, blood pressure sensors, accelerometers, step-counters, or the like or any combination thereof. Various non-limiting examples of sensors that are part of and/or that monitor the environment of a user include thermometers, barometers, altimeters, wind sensors, or the like or any combination thereof.

As already mentioned, the sensors may each be configured to collect signals indicative of physical activities performed by the user 102 and/or of activities or states associated with the user 102 that occur in the real world. For instance, in the illustrated embodiment, the user 102 is ascending stairs 112, and each sensor may collect a signal indicative of the user 102 ascending stairs 112 or of a state—such as an elevated heart rate or an elevated breathing rate—associated with ascending stairs 112. Of course, the user 102 may perform any of a variety of physical activities including, but not limited to, ascending stairs, descending stairs, walking, running, hiking, road biking, mountain biking, roller blading, roller skating, hang gliding, carpooling or performing some other physical activity or interacting with other users that carry one or both of a lifestyle device 104 and/or a smartphone 106, and the like.

The lifestyle device 104 may be embodied as a portable electronic device (PED) and may be carried by the user 102 throughout the day and/or at other times. Whether or not the lifestyle device 104 is carried by the user 102 throughout the day and/or at other times, the lifestyle device 104 may be configured to, among other things, analyze signals collected by one or more sensors within the environment 100 to identify or validate at least some of the physical activities performed by and/or states associated with the user 102. In these and other embodiments, the lifestyle device 104 may be a device dedicated for performing such functionality. The lifestyle device 104 may include at least one onboard sensor for collecting such signals. Alternately or additionally, the smartphone 106 may include at least one sensor and may communicate signals collected by its onboard sensor to the lifestyle device 104, and/or the lifestyle device 104 may communicate with the sensor 110 or other separate sensors to receive signals collected by the sensor 110 or other separate sensor(s).

Alternately or additionally, the smartphone 106 may be carried by the user 102 throughout the day and/or at other times. Whether or not the smartphone 106 is carried by the user 102 throughout the day and/or at other times, the smartphone 106 may include an app, e.g., a small specialized program, configured to be executed by the smartphone 106 to cause the smartphone 106 to analyze signals collected by at least two sensors within the environment 100 to identify or validate at least some of the activities performed by and/or states associated with the user 102. In these and other embodiments, the smartphone 106 may include at least one onboard sensor for collecting such signals. Alternately or additionally, the lifestyle device 104 may include at least one sensor and may communicate signals collected by its onboard sensor to the smartphone 106, and/or the smartphone 106 may communicate with the sensor 110 or other separate sensors to receive signals collected by the sensor 110 or other separate sensor(s).

Alternately or additionally, the server 108 may be configured to receive signals collected by one or more sensors or other devices, such as the lifestyle device 104 or smartphone 106, within the environment 100. The server 108 may be further configured to analyze the received signals to identify or validate at least some of the activities performed by and/or states associated with the user 102. The signals may be collected by one or more sensors in the lifestyle device 104, one or more sensors in the smartphone 106, and/or the sensor 110 or other separate sensor(s).

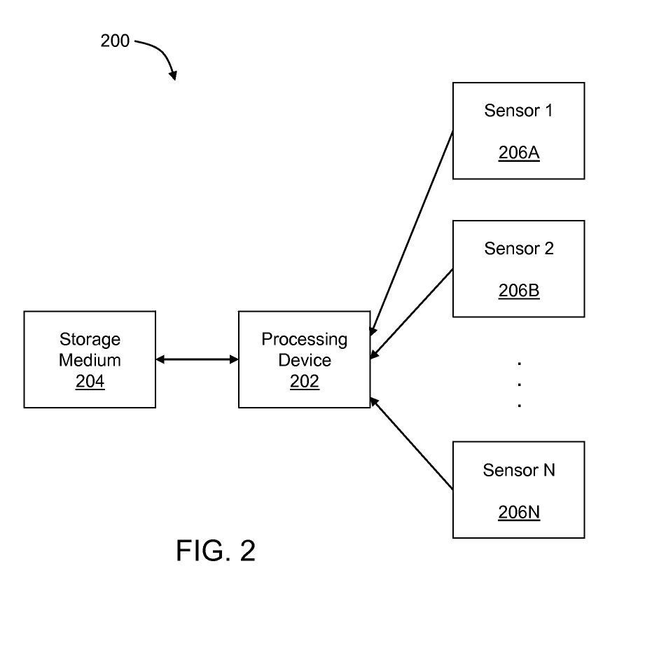

FIG. 2 illustrates an example system 200 that can be implemented in the environment 100 of FIG. 1 to perform some or all of the functions described herein. The system 200 includes a processing device 202, a computer-readable storage medium 204, and one or more sensors. The one or more sensors may include, for instances, a first sensor 206A, a second sensor 206B, and/or an Nth sensor 206N (generically hereinafter “sensor 206” or “sensors 206”).

The processing device 202 may correspond to any one of the lifestyle device 104, the smartphone 106, or the server 108 of FIG. 1, or to a processor, controller, microprocessor, microcontroller, or other processing device included therein. In general, the processing device 202 may be configured to access and execute computer-executable instructions that, when executed, cause the processing device to perform one or more of the functions or operations described herein. For instance, execution of the computer-executable instructions may cause the processing device 202 to, among potentially other things, implement platform mechanics described below, including receiving one or more signals generated by one or more of the sensors 206, analyzing the signals to validate that an activity was performed by the user 102 (FIG. 1) in the real world and/or to validate that a state associated with the user 102 occurred, and awarding virtual currency to the user 102 in response to validating that the activity was performed by the user 102 or that the state occurred. Alternatively or additionally, validated activity may lead directly to a real-world reward without going through a virtual currency. Examples of real-world rewards include, but are not limited to, a gift card, an account credit, a coupon, a voucher, or a donation in the real world.

The computer-readable storage medium 204 may be provided onboard the lifestyle device 104 and/or the smartphone 106, or at the server 108 or at another location. The computer-readable storage medium 204 may include any device configured to carry or have computer-executable instructions or data structures stored thereon. For instance, the computer-readable storage medium may include, but is not limited to, random access memory (RAM), read only memory (ROM), electrically erasable and programmable ROM (EEPROM), compact disc-ROM (CD-ROM), or other optical disk storage, magnetic disk storage or other magnetic storage devices, flash storage or other solid state storage, or any other medium which can be used to carry or store desired program code means in the form of computer-executable instructions or data structures. The computer-executable instructions or data structures may be effective to cause the processing device 202 to perform one or more of the functions or operations described herein.

Each of the sensors 206 may correspond to a respective one of the sensors included in FIG. 1, such as a sensor included in the lifestyle device 104, a sensor included in the smartphone 106, or a separate sensor such as the sensor 110. As such, each sensor 206 may be configured to collect signals indicative of a physical activity performed by the user 102 in the real world or of an activity or state associated with the user 102 that occurs in the real world. The state may include a heart rate, blood pressure, breathing rate, blood oxygen level, or other physiological indicator of the user 102, for example. It may alternately or additionally include environmental measurements such as temperature, altitude, wind speed, or the like.

Each of the sensors 206 may include, but is not limited to, an altimeter, an accelerometer, a gyroscope, an electronic compass, a GPS device, a physiological sensor, an aural sensor, a light sensor, a camera, or a network interface. A network interface may be used to, among other things, sense locations, and may include, but is not limited to, a Wi-Fi receiver, a Bluetooth receiver, a Near Field Communication (NFC) receiver, a wide area network (WAN) receiver, or a receiver that supports communications compliant with at least one mobile communication standard such as the 3G, EDGE, and 4G mobile communication standards.

The system 200 of FIG. 2 may be incorporated into a single device or distributed across multiple devices. For instance, at least the processing device 202 and storage medium 204 may be included in the lifestyle device 104, the smartphone 106 or the server 108 of FIG. 1. The device that includes the processing device 202 and the storage medium 204 may optionally include one or more of the sensors 206 as well. Alternately, one or more of the sensors 206 may be provided as a separate sensor or in a separate device, as already described above with respect to FIG. 1.

One or more of the lifestyle device 104, the smartphone 106, or the server 108 may support platform mechanics in accordance with the embodiments described herein. In the present application, platform mechanics may refer to, among other things, how and where virtual currency may be generated and/or consumed by the user 102. Virtual currency refers to anything of value represented virtually that can be used for value creation in a virtual world or in the real world. The virtual world may be the world or environment within a computer game, for instance. The platform mechanics in these and other embodiments may be embodied in the computer-readable storage medium 204 of FIG. 2 as computer-executable instructions that are executable by the processing device 202 to carry out one or more of the functions and operations described herein.

Alternately or additionally, the virtual currency described herein may include different types of currency. For instance, in an example embodiment, the platform mechanics implement two types of currency and may therefore be referred to as a dual-currency system. The two types of virtual currency may include a coin-based virtual currency and an energy-based virtual currency. In some embodiments, coin-based virtual currency such as virtual coins may be generated as a consequence of events set in motion by the user 102 in a virtual world. In contrast, energy-based virtual currency may be generated by validating activities or states in the real world. Energy-based virtual currency may alternately or additionally be referred to herein as energy points or Striiv energy, or the like.

For simplicity in the discussion that follows, various operations, steps and/or functions will be described as being performed by the lifestyle device 104. More generally, however, any one of the lifestyle device 104, smartphone 106 or server 108 of FIG. 1 may perform any or all of the operations, steps and/or functions.

In general, energy-based virtual currency may be awarded as a mapping between a recognizable activity in the real world (such as taking a step or gaining elevation through climbing stairs, hiking up a hill, or the like) or state in the real world (such as having a heart rate, blood pressure, or breathing rate that is above or below a selected threshold, or the like) and the awarded energy-based virtual currency. The purpose of the mapping may be to reward choices that advance a goal of promoting physical well-being of the user 102. For instance, while energy may be awarded for taking a step while either walking or running, the award per step may be greater for running than for walking as running may advance the user 102 toward the goal of physical well-being quicker than walking.

Thus, in some embodiments, virtual currency such as energy-based virtual currency is generated based on behaviors, activities, or states in the real world. For instance, activities performed by the user 102 in the real world such as walking, running, ascending stairs 112, carpooling with another user(s) who also has a lifestyle device 104 or smartphone 106, or connecting to the server 108 can generate energy-based virtual currency. Connecting to the server 108 can occur or in real time, or can involve posting results from one user and receiving and acting on those results at some time in the future by the other user, for example. Alternately or additionally, an elevated heart rate, breathing rate, or other physiological state indicative of being engaged in physical activities can generate energy-based virtual currency. More generally, any activity or state in the real world can be used to generate energy-based virtual currency or can lead directly to a reward in the real world so long as the real world activity or state can be validated by the lifestyle device 104.

The activities or states can be validated by analyzing the signal(s) generated by the sensor(s) that are provided to the lifestyle device 104 and determining whether the signal(s) are indicative of the activities or states. For instance, signal(s) from one or both of an altimeter and accelerometer can be used to validate that a user performed an activity such as walking, running, ascending stairs, or the like, and the signal(s) may alternately or additionally be used to determine the number of steps (or other repetitive motions) that were taken by the user 102 while performing the activity. As another example, signal(s) from a network interface and a GPS receiver can be used to validate that the user performed an activity such as carpooling with another user who also has a lifestyle device 104, e.g., the lifestyle device 104 of the user 102 can communicate with the lifestyle device 104 of the other user through the network interface to confirm that they are in proximity with each other and the GPS receiver of the lifestyle device 104 can receive signals that can be analyzed to determine that the user is traveling at 50 miles per hour (mph) on a known motorized commuter route. As another example, signal(s) from a light sensor, microphone, or NFC interface can be used to validate that the user is participating in, e.g., a food drive or other activity associated with a particular location, e.g., the light sensor, microphone, or NFC interface can collect signals from a barcode scanner, acoustic beacon, or other device with an NFC interface at the particular location to validate that the user is at the particular location. As yet another example, a signal from a sensor such as a heart rate monitor can be used to validate that the heart rate of the user is above a selected threshold, which may indicate that the user is engaged in any of a variety of physical activities.

The foregoing examples are only illustrative of some activities or states that can be validated and of some methods for validating and are not limiting. More generally, virtually any real world activity or state can be validated by analyzing a signal indicative of the real world activity or state that has been collected by a corresponding sensor.

An amount of the energy-based virtual currency awarded to the user 102 in response to validating the activity or state may depend on any of a variety of factors including, but not limited to, a duration of the activity or state, a number of repetitive motions performed in the activity, or a health benefit associated with the activity state. For instance, the amount of the energy-based virtual currency awarded to the user 102 for a given activity or state may increase with increasing duration of the given activity or state.

As another example, and in general terms, the amount of energy-based virtual currency awarded to the user 102 for a given activity or state may increase according to any algorithm, such as linearly, non-linearly, function-based, decision-based, or the like.

For instance, the amount of the energy-based virtual currency awarded to the user 102 for a given activity or state may increase linearly with increasing number of repetitive motions performed in the activity. For example, a predetermined amount may be awarded for each step (or other repetitive motion) taken while walking, running, ascending stairs, or the like. As a specific example, five points (or other currency) per step may be awarded for running.

As another example, the amount of energy-based virtual currency awarded to the user 102 for a given activity or state may increase by a first amount per repetitive motion up to a first number of repetitive motions and by a second amount per repetitive motion after exceeding the first number of repetitive motions. For instance, five points (or other currency) per step may be awarded up to 2000 steps for running, followed by only three points per step for each step after 2000 steps.

As another example, the amount of energy-based virtual currency awarded to the user 102 for a given duration or a given number of repetitive motions performed in the activity or state may be greater for a first activity or state having a first associated health benefit than for a second activity or state having a second associated health benefit that is less than the first associated health benefit. For instance, it may be the case that the platform mechanics consider running to have a higher health benefit than walking. Thus, five points (or other currency) per step may be awarded for running while only three points per step may be awarded for walking.

Alternately or additionally, a social multiplier may be applied when an activity or state is performed by multiple users in the physical presence of each other or when connected through the server 108, where each user has a lifestyle device 104. In this example, the activity itself can be validated as described above by analyzing one or more signals indicative of the activity, and the users being in each other's physical presence (or connected through the server 108) can be validated by analyzing signals collected by respective network interfaces of the lifestyle devices 104 that confirm that the lifestyle devices 104 were near one another (or were connected to the server 108). For instance, the network interface of each lifestyle device 104 may include an NFC interface. In this example, the social multiplier may multiply the amount of energy-based virtual currency that would have been awarded for performing the activity alone by some constant (e.g., 1.5 to award a 50% bonus) to reward the user 102 for performing the activity with another user. The multiplier may alternately or additionally also extend to users who are connected to the server 108. Thus, the social multiplier may be used to incentivize users to interact with each other face-to-face rather than virtually or not at all, which may provide a health benefit to the users.

The energy-based virtual currency awarded to the user 102 may be consumed in any of a variety of ways. For instance, the energy-based virtual currency can be redeemed for value in a virtual world, such as in a game on the lifestyle device 104, or in the real world.

Redeeming the energy-based virtual currency for value in the virtual world can include purchasing anything of value in the virtual world. Of course, those items that have value in the virtual world may depend on the virtual world. For instance, a virtual world in, e.g., a farming game played on the lifestyle device 104, may value virtual water, virtual farming tools, virtual seeds, virtual livestock, or other virtual items that can be used to improve a farm.

Alternately or additionally, redeeming the energy-based virtual currency for value in the virtual world can include redeeming the energy-based virtual currency to drive events in the virtual world. For instance, the energy-based virtual currency may be redeemed as energy for an avatar in a virtual world of a game, where the avatar consumes the energy to perform activities within the virtual world, or as energy to plant a seed, tend and cultivate it, and harvest any produce it produces.

In some embodiments, the events driven in the virtual world may be closely tied to the activity or state validated to obtain the energy-based virtual currency. For instance, in some embodiments, ascending an incline in a virtual world may require that the user 102 ascend an incline in the real world. Validating that the user 102 ascended the incline in the real world can serve to allow the incline in the virtual world to also be ascended (e.g., by an avatar). Thus, the energy-based virtual currency awarded in this example drives the avatar to ascend the incline in the virtual world.

Alternately, the energy-based virtual currency can be redeemed for value in the real world. Redeeming the energy-based virtual currency for value in the real world may include, but is not limited to, exchanging the energy-based virtual currency for a gift card, an account credit, a coupon, a voucher, or a donation in the real world. For instance, a certain amount of energy-based virtual currency may be exchanged for a $10 (or some other value) gift card to a real world retailer such as Target. Alternately, a certain amount of energy-based virtual currency can be exchanged as a monetary donation to a charity of the user's 102 choosing.

As already indicated, the energy-based virtual currency can be redeemed to drive events in a virtual world. In these and other embodiments, the lifestyle device 104 may be used to persistently monitor and collect signals indicative of physical activities or states of the user, which physical activities or states of the user 102 can be used to drive events in the virtual world. This is distinct from devices such as the NINTENDO WII and MICROSOFT KINECT which instead support session-based game play and are confined to a particular location. In particular, a user has to be actively engaged with the corresponding game console and be in the proximity of the corresponding game console which is tied to a power source and a display, and is therefore confined to a location. In contrast, the user 102 can carry the lifestyle device 104 around throughout the day at work, walking to and from work, and in other situations where the user 102 is not actively engaged with operating the lifestyle device 104. By persistently monitoring the user's 102 activities, the lifestyle device 104 can nevertheless determine the activities performed by and/or the states associated with the user and use those activities and/or states to drive events in a virtual world.

In these and other embodiments, the virtual world may include a virtual quest where the user 102 drives the virtual quest by performing physical activities that minor or approximate virtual activities that are required to complete the virtual quest. Two examples of virtual quests include virtually climbing the Eiffel Tower or virtually crossing the Golden Gate Bridge. To complete the virtual quest, the user 102 may perform the same physical activities that would be required to complete the same quest in the real world, while being able to perform the physical activities at any location in the real world. For instance, to virtually climb the Eiffel Tower in a virtual world, the user 102 may have to climb as many stairs as would be required to climb the Eiffel Tower in the real world. However, the stairs climbed by the user 102 can be anywhere such that the user 102 does not have to be in France to complete the virtual quest. As another example, to virtually cross the Golden Gate Bridge in a virtual world, the user 102 may have to take as many steps, either walking or running, as would be required to cross the Golden Gate Bridge in the real world. In this example, the steps taken by the user 102 can be taken anywhere in the real world such that the user 102 does not have to be in California to complete the virtual quest. Thus, events in the virtual world driven by activities in the real world that are closely tied to the activities in the real world may involve virtual activities that parallel or correspond to the real world activities, although the activities in the real world need not take place in a parallel geographic location as the virtual activities.

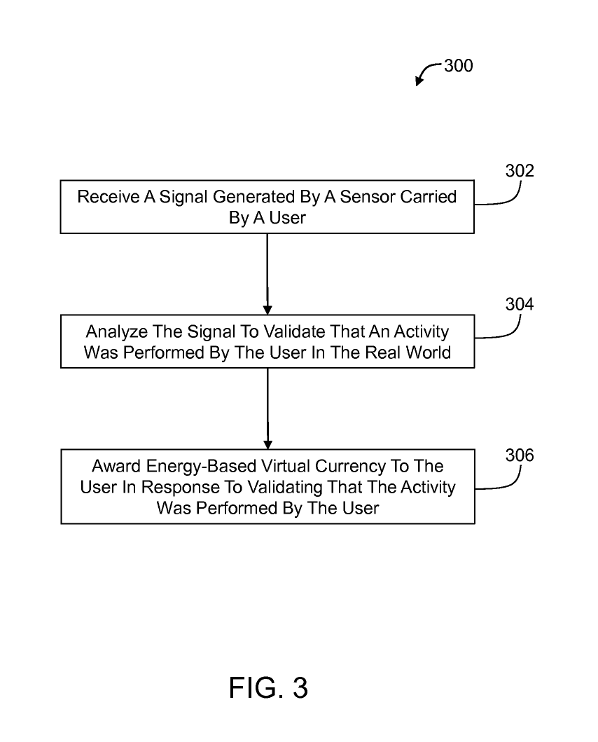

FIG. 3 is a flowchart of an example method 300 of generating energy-based virtual currency as part of the platform mechanics described herein. The method 300 may be performed in whole or in part by any one or more of the lifestyle device 104, the smartphone 106 and/or the server 108. For simplicity, the method 300 will be described as being performed by the lifestyle device 104 in the environment 100 of FIG. 1. In the following example, the lifestyle device 104 can communicate with one or more sensors for collecting signals indicative of activities performed by the user 102.

In block 302, the lifestyle device 104 receives a signal generated by a sensor carried by the user 102. The signal may be collected by the sensor and may be indicative of one or more activities performed by the user 102 in the real world. Alternately or additionally, the signal may be indicative of a state of the user 102.

In block 304, the lifestyle device 104 analyzes the signal to validate that an activity was performed by the user in the real world. The activity may include, but is not limited to, walking, running, biking, ascending stairs, descending stairs, or carpooling with another user that also has a lifestyle device 104. Alternately or additionally, the lifestyle device 104 analyzes the signal to validate that a state of the user occurred in the real world. The state may include a heart rate, breathing rate, blood pressure, blood oxygen level, calories consumed, or other physiological indicator being above a selected threshold, below a selected threshold, or the like.

In block 306, the lifestyle device 104 awards energy-based virtual currency or some other virtual currency to the user 102 in response to validating that the activity was performed by the user 102. Alternately or additionally, the lifestyle device 104 awards energy-based virtual currency or some other virtual currency to the user 102 in response to validating that the state occurred.

An amount of the energy-based (or other) currency awarded to the user 102 may depend on at least one of a number of repeatable motions performed in the activity or a health benefit associated with the activity or state, a duration of the activity or state, or the like or any combination thereof. Various examples of the foregoing have already been described above.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 300 may further include, prior to receiving the signal generated by the sensor, incentivizing the user 102 to modify a repeating real-world behavior to include the activity or to cause the state to occur. For instance, the activity may include walking up stairs on the way to work on Monday through Friday, and the repeating real-world behavior may be a repeating daily behavior including the user 102 riding the elevator to work. Alternately or additionally, the state may include an elevated heart rate associated with walking up the stairs on the way to work. Thus, it may be beneficial health-wise to incentivize the user 102 to walk up the stairs rather than riding the elevator. Incentivizing the user 102 to modify the real-world behavior to include the activity or cause the state to occur may include notifying the user 102 that the user 102 will be awarded the energy-based virtual currency for modifying the repeating real-world behavior to include the activity or cause the state to occur.

In this and other embodiments, the method 300 may further include, prior to incentivizing the user 102 to modify the repeating real-world behavior to include the activity or cause the state to occur, identifying the repeating real-world behavior that does not include performance of the activity, and identifying the activity or state as an activity or state that would benefit a physical condition of the user. Various example embodiments of identifying real-world behaviors (life pattern detection) and identifying the modification to the real-world behavior (modification suggestion) using a lifestyle device 102 or other PED are described in U.S. Provisional Application No. 61/529,674 filed Aug. 31, 2011 and entitled LIFE PATTERN DETECTION, which application has been previously incorporated by reference herein.

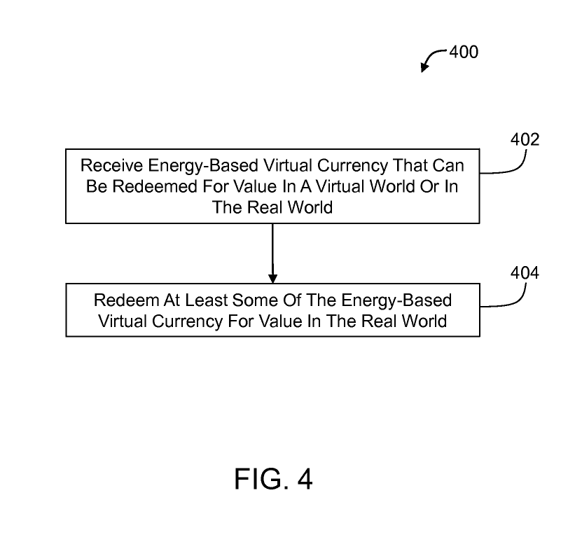

FIG. 4 is a flowchart of an example method 400 of redeeming energy-based virtual currency as part of the platform mechanics described herein. The method 400 may be performed in whole or in part by the user 102 through one or more of the lifestyle device 104, the smartphone 106 and/or the server 108. For simplicity, the method 400 will be described as being performed through the lifestyle device 104 in the environment 100 of FIG. 1.

In block 402, the user 102 receives energy-based virtual currency that can be redeemed for value in a virtual world or in the real world. The virtual world may correspond to a game played on the lifestyle device 104 by the user 102 or some other virtual construct supported by the lifestyle device 104 or other processing device. The user 102 may be notified of the reception of the energy-based virtual currency through an output device of the lifestyle device 104, for instance.

In block 404, the user 102 redeems at least some of the energy-based virtual currency for value in the real world. For instance, the user 102 may navigate a graphical user interface (GUI) of the lifestyle device 102 to select something of value in the real world for which the energy-based virtual currency may be redeemed. Redeeming at least some of the energy-based virtual currency for value in the real world may include exchanging the at least some of the energy-based virtual currency for a gift card, an account credit, a coupon, a voucher, or a donation in the real world.

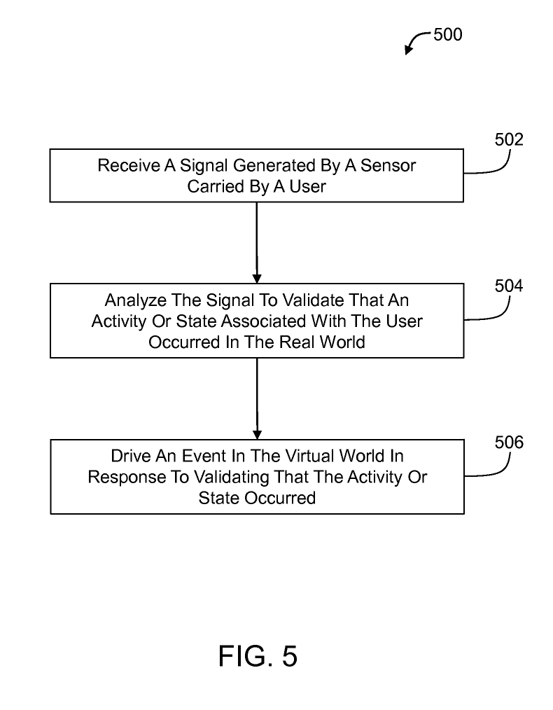

FIG. 5 is a flowchart of an example method 500 of harvesting activities or states in the real world to drive events in a virtual world. The method 500 may be performed in whole or in part by the lifestyle device 104, the smartphone 106, and/or the server 108 of FIG. 1. For simplicity, the method 500 will be described as being performed by the lifestyle device 104 in the environment 100 of FIG. 1.

In block 502, the lifestyle device 104 receives a signal generated by a sensor carried by the user 102. The signal may be collected by the sensor and may be indicative of one or more activities performed by the user 102 in the real world or of one or more states of the user 102 in the real world.

In block 504, the lifestyle device 104 analyzes the signal to validate that an activity or state associated with the user occurred in the real world. The activity may include, but is not limited to, walking, running, biking, ascending stairs, descending stairs, or carpooling with another user that also has a lifestyle device 104. The state may include, but is not limited to, having a heart rate, breathing rate, blood pressure, blood oxygen level, or other physiological indicator that is above or below a selected threshold.

In block 506, the lifestyle device 104 drives an event in the virtual world in response to validating that the activity or state occurred. The virtual world may correspond to a game played on the lifestyle device 104.

The event in the virtual world may be closely tied to the activity in the real world or loosely tied to the activity in the real world. In some embodiments, the event in the virtual world is closely tied to the activity in the real world if the activity in the real world is of a same species as the event in the virtual world or is otherwise substantially similar to the event in the virtual world. For instance, if the event in the virtual world is, e.g., gaining an elevation (e.g., through climbing a tree, climbing a hill, climbing some stairs, etc.), the validated activity may also be an activity in the real world in which the user 102 gains an elevation. Alternately or additionally, the event in the virtual world may be loosely tied to the activity in the real world if the activity in the real world is of a same genus as the event in the virtual world. For instance, if the event in the virtual world is an action of an avatar or an action in the virtual world that requires an energy expenditure (e.g., gaining an elevation, planting a garden, etc.), the validated activity may be an activity in the real world that also requires an energy expenditure (e.g., a physical activity such as walking, running, ascending stairs, biking, etc.).

Some embodiments disclosed herein include a computer-readable storage medium having computer-executable instructions stored thereon that are executable by a processing device to perform operations included in one or more of the methods 300, 400, 500 of FIGS. 3-5, such as the operations illustrated by one or more of the blocks in FIGS. 3-5, and/or variations thereof. The computer-readable storage medium and the processing device may include, for instance, the computer-readable storage medium 204 and the processing device 202 of FIG. 2.

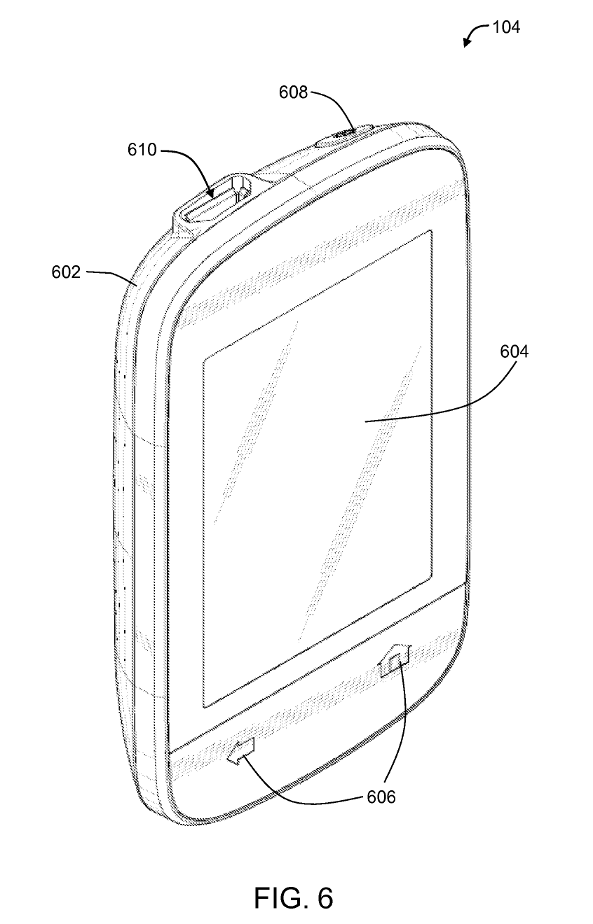

FIG. 6 illustrates an example embodiment of the lifestyle device 104 of FIG. 1. The lifestyle device 104 of FIG. 6 may be configured to perform some or all of the methods 300, 400, 500 of FIGS. 3-5, variations thereof, and/or any other functions or operations described herein.

In the embodiment of FIG. 6, the lifestyle device 104 includes a housing 602, a display 604, one or more user interface (UI) buttons 606, a power button 608, and an electrical port 610. Although not shown, the lifestyle device 104 may additionally include at least one processing device corresponding to the processing device 202 of FIG. 2, a computer-readable storage medium corresponding to the computer-readable storage medium 204 of FIG. 2, one or more sensors corresponding to the sensors 206 of FIG. 2, and potentially other electronic components such as a battery enclosed within the housing 602.

The display 604 is configured to output data in a visual form to a user and is only one example of an output device that may be provided in the lifestyle device 104. Alternately or additionally, the lifestyle device 104 may include one or more speakers, vibrators, or other output devices that output data in an aural form, tactile form, or some other form. Further, in some embodiments, the display 604 may include a touch-sensitive display configured to receive input from the user. Other input devices may alternately or additionally be provided in the lifestyle device 104, such as the buttons 606 that may be used by the user to, e.g., navigate a GUI of the lifestyle device 104.

The power button 608 may be configured to turn the lifestyle device 104 on or off.

The electrical port 610 may be configured to receive an electrical connector of an electrical cord for charging a battery of the lifestyle device 104 or providing a hardwired network connection between the lifestyle device 104 and a host device such as a desktop or laptop computer of the user.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating energy-based virtual currency, the method comprising:
receiving a signal generated by a sensor carried by a user;
analyzing the signal to validate that:
an activity was performed by the user in the real world; or
a state associated with the user occurred in the real world; and
awarding energy-based virtual currency or a reward in the real world to the user in response to validating that:
the activity was performed by the user; or
the state associated with the user occurred in the real world.

2. The method of claim 1, wherein:
the activity comprises walking, running, biking, ascending stairs, descending stairs, or carpooling with another user; or
the state comprises having a heart rate, blood pressure, breathing rate, or blood oxygen level that is above or below a selected threshold.

3. The method of claim 1, wherein an amount of the energy-based virtual currency awarded to the user depends on at least one of a number of repetitive motions performed in the activity or state or a health benefit associated with the activity or state.

4. The method of claim 3, wherein the amount of the energy-based virtual currency awarded to the user for a given activity or state increases linearly with increasing number of repetitive motions performed in the activity or state.

5. The method of claim 3, wherein the amount of energy-based virtual currency awarded to the user for a given activity or state increases by a first amount per repetitive motion up to a first number of repetitive motions and by a second amount per repetitive motion after exceeding the first number of repetitive motions.

6. The method of claim 3, wherein the amount of the energy-based virtual currency awarded to the user for a given number of repetitive motions performed in the activity or state is greater for a first activity or state having a first associated health benefit than for a second activity or state having a second associated health benefit that is less than the first associated health benefit.

7. The method of claim 3, wherein each of the repetitive motions comprises a step taken while walking, running, or ascending stairs.

8. The method of claim 1, further comprising, prior to receiving the signal generated by the sensor, incentivizing the user to modify a repeating real-world behavior to include the activity or to cause the state to occur.

9. The method of claim 8, further comprising, prior to incentivizing the user to modify the repeating real-world behavior to include the activity or to cause the state to occur:
identifying the repeating real-world behavior that does not include performance of the activity or does not cause the state to occur; and
identifying the activity or state as an activity or state that would benefit a physical condition of the user.

10. The method of claim 8, wherein incentivizing the user to modify the repeating real-world behavior to include the activity or to cause the state to occur includes notifying the user that the user will be awarded the energy-based virtual currency for modifying the repeating real-world behavior to include the activity or to cause the state to occur.

11. A method of redeeming energy-based virtual currency, the method comprising:
receiving energy-based virtual currency that can be redeemed for value in a virtual world or in the real world; and
redeeming at least some of the energy-based virtual currency for value in the real world.

12. The method of claim 11, wherein redeeming at least some of the energy-based virtual currency for value in the real world includes exchanging at least some of the energy-based virtual currency for a gift card, an account credit, a coupon, a voucher, or a donation in the real world.

13. A method of harvesting activities or states in the real world to drive events in a virtual world, the method comprising:
receiving a signal generated by a sensor carried by a user;
analyzing the signal to validate that an activity or state associated with the user occurred in the real world; and
driving an event in the virtual world in response to validating that the activity or state occurred.

14. The method of claim 13, wherein the event in the virtual world is closely tied to the activity or state in the real world.

15. The method of claim 14, wherein the event in the virtual world is closely tied to the activity or state in the real world when the event in the virtual world involves a virtual activity that is substantially similar to the activity in the real world.

16. The method of claim 14, wherein at least one of:
the activity in the real world includes the user ascending an incline in the real world and the event in the virtual world includes ascending an incline in the virtual world; or
the activity in the real world includes the user performing a physical activity in the real world and the event in the virtual world includes improving a physical condition of an avatar representing the user in the virtual world.

17. The method of claim 13, wherein the event in the virtual world is loosely tied to the activity or state in the real world.

18. The method of claim 17, wherein the activity in the real world includes an expenditure of energy by the user and the event in the virtual world includes at least one of:
gaining an elevation, planting a seed, planting a garden, tending and cultivating the seed or garden, or harvesting produce produced by the seed or garden.

19. The method of claim 17, wherein the event in the virtual world can be realized by the user performing any one of multiple activities capable of being validated, the multiple activities including the activity.

20. The method of claim 13, wherein the event is either closely tied to the activity in the real world or loosely tied to the activity in the real world.

21. The method of claim 20, wherein:
the event in the virtual world is closely tied to the activity in the real world if the activity in the real world is of a same species as the event in the virtual world; and
the event in the virtual world is loosely tied to the activity in the real world if the activity in the real world is of a same genus as the event in the virtual world.
